(19) United States
(12) Patent Application Publication
(10) Pub. No.: US 2006/0278483 A1
(43) Pub. Date: Dec. 14, 2006

(54) Adjustable damping shock absorbers

(75) Inventor: Bofu Jiang, Songjiang (CN)

Correspondence Address: EMIL CHANG;LAW OFFICES OF EMIL CHANG, 874 JASMINE DRIVE, SUNNYDALE, CA, 94086, US

(73) Assignee: BYD Company Limited

(21) Appl. No.: 11/478,113

(22) Filed: Jun. 28, 2006

(30) Foreign Application Priority Data
Jun. 8, 2005 (CN) 200510021212.9

(51) Int. Cl. F16F 9/34

(52) U.S. Cl. 188/266.4; 188/299.1

(57) ABSTRACT

This invention relates to a type of adjustable damping shock absorber, comprising a reservoir, piston rods, and piston bodies. Said reservoir has an upper sealing cap with a through hole. The piston rod is placed in the through hole using a sealing ring. The special characteristics are: said piston body comprises an upper piston body and a lower piston body. A piston rod is connected to the upper piston body and a piston spinning rod is connected to the lower piston body. At the corresponding positions of the upper piston body and the lower piston body, there are passage holes for the passage of a liquid of choice to achieve damping. The lower piston body is connected to a power unit and can be driven by the power unit to spin the lower piston body, thereby changing the intersectional area of the passage holes, and the flow velocity and total flow from one chamber to another chamber within the reservoir is changed, achieving the variable damping adjustment.

### CROSS REFERENCE

This application claims priority from a Chinese patent application entitled “Adjustable Damping Shock Absorbers” filed on Jun. 28, 2005, having a Chinese Application No. 200510021212.9. This application is incorporated herein by reference in its entirety.

### FIELD OF THE INVENTION

This invention relates to the field of adjustable damping shock absorbers, and, in particular, it relates to adjustable damping shock absorbers used in automobile suspension systems.

### BACKGROUND

Shock absorbers are a very important component for automobiles. The properties of shock absorbers directly affect the comfort, operating stability and safety of automobiles. In cars, the shock absorber is used as a part of the suspension system. As society progresses, cars for families are a primary way of transportation. Consumers demand cars to have better features, especially in term of comfort. This requires that the cars can adjust to different road conditions. However, passive suspensions obviously cannot meet this requirement. There is a greater demand for active and semi-active suspensions, especially semi-active suspensions which can change the control parameters of the suspensions. Semi-active suspensions use variable damping shock absorbers. By real-time control and adjusting the damping forces, the suspensions allow the cars to adjust to road conditions and the various operating conditions of the car, thereby achieving comfort for the passenger.

As technologies develop, many new technologies have been applied to shock absorbers. However, due to the disadvantages of these technologies, they are not widely adopted in the automobile field, as an example, the application of magnetorheology of liquid to shock absorbers (see Chinese Patent: 01206530.7). By changing the viscosity of the liquid with magnetic fields, the flowing speed of the liquid is changed, achieving the objective in adjusting damping. However, magnetorheology of liquid has a problem in subsiding suspended particles and it has not been effectively solved. Therefore, adjustable damping shock absorbers using magnetorheology of liquid are not widely adopted.

Currently, there are adjustable damping shock absorbers used in the area of automobiles, such as the shock absorber of active suspension in Benz S350 whose damping has four adjustable modes. Chinese Patent 00249729.8 provides a double-cylinder variable damping hydraulic shock absorber for automobiles, and it only provides 2-5 damping modes. In summary, adjustable damping shock absorbers have been used but there are only a few adjustable damping modes.

### SUMMARY OF THE INVENTION

An object of this invention is to provide a structure to achieve continuously adjustable damping modes for shock absorbers of automobiles thus meeting all road conditions.

Another object of the present invention is to provide structures of the present invention that accounts for manufacturing considerations such that the investments required for manufacturing the embodiments of the present invention is low and the embodiments are easy to manufacture.

To solve the above technical problem, this invention provides adjustable damping shock absorbers comprising one or more oil reservoirs, a piston rod, and piston bodies. Said reservoir's upper sealing cap has a through hole. The piston rod is placed in the hole through a sealing ring. The special characteristics are: said piston body comprises of an upper piston body and a lower piston body. With respect to the upper piston body and the lower piston body, at least one is connected to the piston rod. At the upper piston body and the lower piston body, there are passage holes for the passage of oil or liquid. Among the upper piston body and the lower piston body, at least one is connected to a power unit and can be driven by the power unit to spin a piston body in order the control the flow of the liquid and thereby achieve continuously adjustable damping.

An advantage of this invention is that it provides a structure to achieve continuously adjustable damping modes for shock absorbers of automobiles thus meeting all road conditions.

Another advantage of the present invention is that it provides structures of the present invention that accounts for manufacturing considerations such that the investments required for manufacturing the embodiments of the present invention is low and the embodiments are easy to manufacture.

### FIGURES

The following are further descriptions of the embodiments of the invention with references to figures and examples of their applications.

FIG. 1 is an illustration of an embodiment of the adjustable damping shock absorber of the present invention.

FIG. 2a is an illustration of a fixed body comprising an upper piston body, a piston rod and a mounting bracket.

FIG. 2b is a top-view illustration of the upper piston body and the piston rod.

FIG. 3a is an illustration of the spinning body comprising of a lower piston body and a piston-spinning rod.

FIG. 3b is a top-view illustration of the spinning body.

FIG. 4 is an illustration of when the upper piston body and the lower piston body are in a non-staggered position.

FIG. 5 is an illustration of when the upper piston body and the lower piston body are in a completely staggered position.

FIG. 6 is an illustration of when the upper piston body and the lower piston body are in a randomly staggered position.

FIG. 7 is an illustration of when the upper piston body and the lower piston body are spun to reduce the flow area for the oil.

FIG. 8 is an illustration of when the upper piston body and the lower piston body are spun to increase the flow area for the oil.

### DETAILED DESCRIPTION OF THE PREFERRED EMBODIMENTS

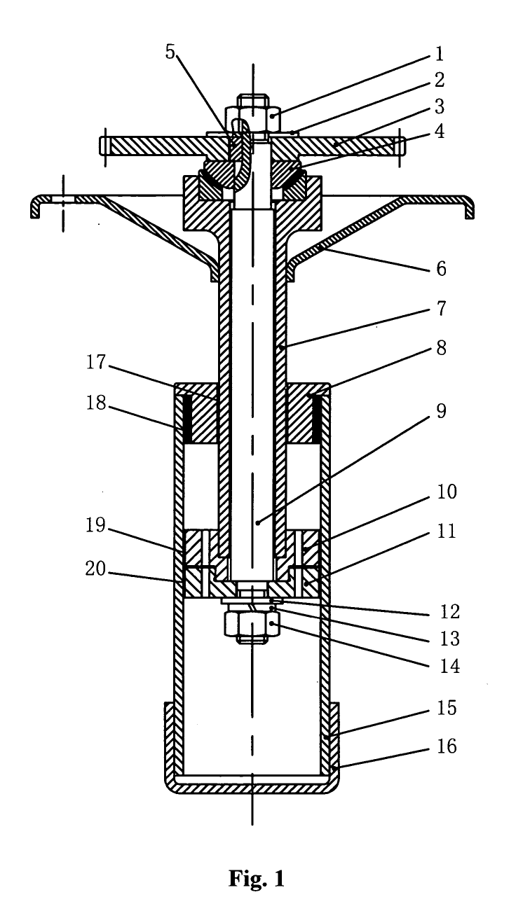

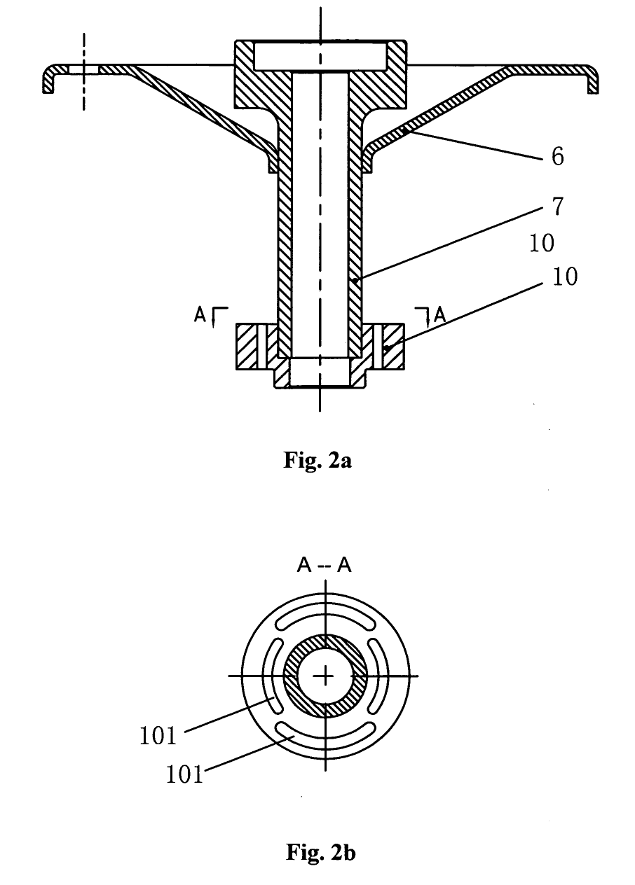

FIG. 1 shows a presently preferred embodiment of an adjustable damping shock absorber is illustrated, which includes an oil reservoir 15, a lower cap of the reservoir 16, an upper cap of the reservoir 8, and a sealing ring 18. The upper cap of the reservoir has a through hole. A piston rod 7 is placed in the through hole through the sealing ring 17. The sealing rings, 19 and 20, are installed where the piston body in the oil reservoir fit in with the inner wall of the oil reservoir. The piston body divides the oil reservoir into two chambers. Note that the damping liquid can be oil or any other liquid.

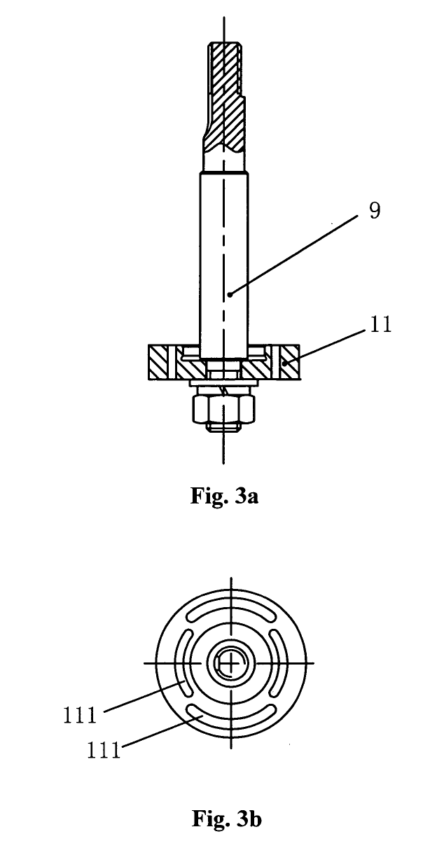

The difference is that the piston body of this invention comprises of an upper piston body and a lower piston body. The upper piston body 10 and the lower piston body 11 both have arc-shaped passage holes along the direction of the axis, enabling the oil to flow from one chamber to another. The arc-shaped passage holes of the upper and lower piston bodies are at the same positions and are of the same sizes. The upper piston body 10 and the piston rod 7 are fixed as one unit (as shown in FIGS. 3a and 3b). The piston rod 7 is hollow to accommodate the piston spin rod 9. The upper part of the piston rod 7 can be welded to the mounting bracket 6. The mounting bracket 6 can help to install the shock absorber on an automobile. There is a mounting base at the upper end of the piston rod 7 where the bearing 4, which is able to withstand an axial load, is installed. The piston spinning rod 9 goes through the piston rod 7 and the bearing 4 with its upper end connected to the location regulating a gear 3 through a plain key 5. The structure is tightened with a bolt 1 and the bolt 1 is locked with a lock washer 2 to prevent the bolt from becoming loose. The location regulating gear 3 presses the bearing 4 axially. The control and execution units drive the location regulating gear 3 to turn.

The control unit can comprise of an ECU and a push button. The execution unit can be an electric motor, a hydraulic chamber, an electromagnetic valve, an oil pump, etc.

In said adjustable damping shock absorbers, the upper piston body 10, the piston rod 7, the mounting bracket 6 and the outer ring of the bearing 4 form a fixed body. The lower piston body 11, the piston spin rod 9, the inner ring of the bearing 4 and the location regulating gear 3 form a spinning body. Driven by the control and execution units, the location regulating gear 3 can drive the fixed body through bearing 4 to turn relative to the upper piston body 10. Thus the arc-shaped passage holes of the lower piston body 11 switches their positions relative to the arc-shaped passage holes of upper piston body 10, changing the cross-sectional area allowable for the oil to flow from one chamber to another, thereby achieving adjustable damping.

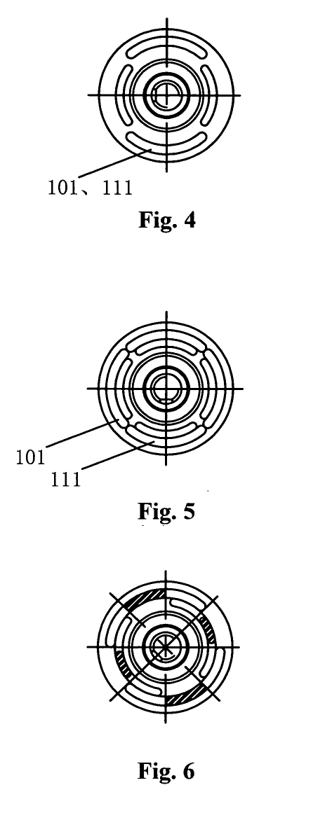

In said adjustable damping shock absorbers, when the location regulating gear 3 turns, it drives the lower piston body 11 to turn while keeping the same angle thus the lower and upper piston body 10 and 11 have countless intersecting positions, creating variable cross-sectional areas as channels for the oil to flow (as shown in FIG. 4, the solid sectional line is the cross-sectional area of the channels), and allowing variable damping modes. Thus it can be called stepless damping.

From said adjustable damping shock absorbers, the ECU of the automobile can receive data from various sensors and process the data. The ECU can then signal the execution unit which executes a desired operation. The process only needs 1˜2×10⁻³s.

When an automobile is parked, the shock absorber does not operate. The damping can be of any status, i.e., the upper piston body 10 and the lower piston body 11 can have any relative positions. The arc-shaped passage holes of the upper and lower piston bodies can have a non-staggered position, as shown in FIG. 4. At that time, the cross-sectional area of the oil flow channels is at its largest and the damping of the shock absorber is at the lowest. The arc-shaped passage holes of the upper and lower piston bodies can have a completely staggered position, as shown in FIG. 5. At that time, the oil flow channels are closed, and the damping of the shock absorber is at the greatest amount. The arc-shaped passage holes of the upper and lower piston bodies can have a randomly staggered position, as shown in FIG. 6. At that time, the cross-sectional area of the oil flow channels can be of any random area, shown as the area of the sectional line in FIG. 6.

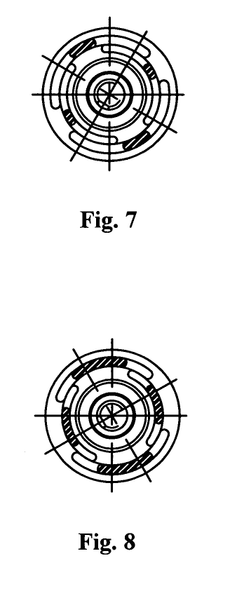

When an automobile is moving, all kinds of sensors—such as speed sensor, wheel speed sensor, acceleration sensor, suspension acceleration sensor, height sensor, shock absorber sensor, etc.—transmit the collected data to the ECU. The ECU then calculates the damping parameter based on the information and current road conditions. The ECU also compares the parameter with the current damping parameter of the shock absorber. When the damping parameter for the current road conditions is greater than the current damping parameter (or when the difference between the two parameters is greater than a preset parameter), the ECU will instruct the control and execution units to drive location regulation gear 3 which drives the lower piston body 11 to turn towards the direction that decreases the cross-sectional area for the oil flow, as shown in FIG. 7. When the damping parameter for the current road conditions is smaller than the current damping parameter (or when the difference between two parameters is greater than a preset parameter), the ECU will instruct the control and execution units to drive the location regulation gear 3 which drives the lower piston body 11 to turn towards the direction that increases the cross-sectional area for the oil flow, as shown in FIG. 8. When the damping parameter for the current road conditions is equivalent to the current damping parameter (or when the difference between the two parameters falls into a range of preset parameters), the ECU will not instruct the control and execution units and the shock absorber automatically maintain the current damping mode.

When the automobile is moving, if the driver is not comfortable with the current damping of the shock absorber, the driver can instruct the control and execution units by pushing one or more buttons. The location regulating gear 3 will drive the lower piston body 11 to turn thus increase or decrease the cross-sectional area for the oil flow, until the driver is comfortable, with the current damping of the shock absorber.

In an embodiment of the present invention, it comprises the following characteristics.

There is a sealing ring installed where the upper sealing cap fits in with the inner wall of the oil reservoir; the sealing rings are installed where piston body in the oil reservoir fit in with the inner wall of the oil reservoir to improve the sealing properties.

Said upper piston body or lower piston body is connected to a power unit with a piston spinning rod.

The lower piston body is connected to a power unit with a piston spinning rod and said upper piston body is fixed to piston rod as one unit; the upper part of the piston rod is connected to an mounting bracket; the upper end of the piston rod has a bearing mounting base where a bearing, which is able to withstand an axial load, is installed; a piston spinning rod goes through the piston rod and the bearing with its upper end connected to a location regulating gear or driving belt.

The location regulating gear can compress the bearing 4 axially.

Said passage holes for the oil are arc-shaped passage holes evenly distributed on the upper and lower piston bodies along the axial direction; the number, location and size parameters of the arc-shaped passage holes of the upper and lower piston bodies correspond to each other.

Said piston rod is hollow to accommodate the piston spinning rod. Since the piston body of said adjustable damping shock absorber comprises a fixed body and a spinning body, a power unit can drive the spinning body to spin relatively to the fixed body, making the passage holes for oil to switch positions thus changing the cross-sectional area of the flowing channels for the oil. Thus the flow velocity and flow of oil from one chamber to another chamber will also change achieving the object in adjusting damping.

Since there are countless switched positions, there are countless cross-sectional areas for the flowing channels for the oil. Therefore, there are countless damping modes, and it can be called stepless or variable damping.

From said adjustable damping shock absorbers, the electronic control unit (ECU) of the automobile receives data from various sensors and processes the data. The ECU then signals the execution unit which executes the operation. The process only needs 1˜2×10⁻³s.

Adopting the solution of this invention can variably and steplessly adjust damping to meet various road conditions. The structure of this invention is simple and it is easy to manufacture.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

Said embodiment is merely an illustration of this invention and not a limitation to this invention. A person of ordinary skills in the art can understand that, without departing from the concept of this invention, there can be various forms for this invention. For example, reservoir 15, its upper sealing cap 8 and lower sealing cap 16 can be an integrated single body. Another example is that the piston spinning rod 9 can be designed as a hollow rod which accommodates piston rod 7 inside. Another example is that the upper piston body 10 can turn and lower piston body 11 is fixed, and so forth.

We claim:

1. An adjustable damping shock absorber, comprising
a reservoir having a through hole;
an upper piston body having one or more first passage holes;
a lower piston body having one or more second passage holes, said upper piston body and said lower piston body dividing said reservoir into two chambers;
a piston rod passing through the through hole and secured with said upper piston body, wherein the center of said piston rod is hollow;
a piston spinning rod inserted in the hollow center of said piston rod and secured against said lower piston body;
a power unit rotating said piston spinning rod to rotate said lower piston body to vary the amount of opening between said first and second passage holes, thereby varying the amount of damping liquid passing through said first and second passage holes.

2. The adjustable damping shock absorber of claim 1 wherein, the reservoir has an upper cap and said through hole is in said upper cap to allow for the insertion and movement of the piston rod within the reservoir.

3. The adjustable damping shock absorber of claim 1 wherein the upper piston body and the lower piston body fit closely with the inner wall of the reservoir.

4. The adjustable damping shock absorber of claim 1 wherein the number, location and size parameters of the first passage holes and the second passage holes correspond to each other.

5. The adjustable damping shock absorber of claim 4 wherein said passage holes are arc-shaped holes evenly distributed on the upper and lower piston bodies.

6. The adjustable damping shock absorber of claim 4 wherein the first passage holes and the second passages holes overlaps to create different amount of opening for the passage of the damping liquid.

7. The adjustable damping shock absorber of claim 5 wherein the first passage holes and the second passages holes overlaps to create different amount of opening for the passage of the damping liquid.

8. An adjustable damping shock absorber, comprising
a reservoir having an upper cap with a through hole;
an upper piston body having one or more first passage holes;
a lower piston body having one or more second passage holes, said upper piston body and said lower piston body dividing said reservoir into two chambers, wherein the number, location and size parameters of the first passage holes and the second passage holes correspond to each other, wherein the upper piston body and the lower piston body fit closely with the inner wall of the reservoir;
a piston rod passing through the through hole and secured with said upper piston body, wherein the center of said piston rod is hollow;
a piston spinning rod inserted in the hollow center of said piston rod and secured against said lower piston body;
a power unit rotating said piston spinning rod to rotate said lower piston body to vary the amount of opening between said first and second passage holes, thereby varying the amount of damping liquid passing through said first and second passage holes.

9. The adjustable damping shock absorber of claim 8 wherein the first passage holes and the second passages holes overlaps to create different amount of opening for the passage of the damping liquid.

10. The adjustable damping shock absorber of claim 8 wherein said passage holes are arc-shaped holes evenly distributed on the upper and lower piston bodies.
